(19) United States
(12) Patent Application Publication
(10) Pub. No.: US 2007/0078768 A1
(43) Pub. Date: Apr. 5, 2007

(54) SYSTEM AND A METHOD FOR CAPTURE AND DISSEMINATION OF DIGITAL MEDIA ACROSS A COMPUTER NETWORK

(76) Inventor: Chris Dawson, Portland, OR (US)

Correspondence Address: GANZ LAW, P.C., P O BOX 2200, HILLSBORO, OR, 97123, US

(21) Appl. No.: 11/534,594

(22) Filed: Sep. 22, 2006

Related U.S. Application Data
(60) Provisional application No. 60/719,338, filed on Sep. 22, 2005.

(51) Int. Cl. G06Q 99/00

(52) U.S. Cl. 705/50

(57) ABSTRACT

A system and a method for creation of digital media and broadcast or publishing of that media across a computer network by connection of a removable storage device.

### RELATED APPLICATIONS

This application claims the benefit of and priority to U.S. Provisional Application Ser. No. 60/719,338, filed Sep. 22, 2005, the contents of which are hereby incorporated by reference as if recited in full herein for all purposes.

### BACKGROUND

The inventive subject matter disclosed herein generally relates to digital media creation and storage computer systems operating on a network.

Media creation systems have existed for several years. Typically these systems are a manual and arbitrary combination of different components from different software and hardware vendors. Digital media creation appliances exist which create media by manual interaction using a keyboard, monitor and mouse. Operation of a digital media creation system is generally too complicated for anyone but highly trained and technically savvy digital media content creators. Publishing systems also exist which can move digital media files around across different networks. However, there is no integrated system which combines these features into one complete system, and is aware of all connected components. Thus, there is a need for an improved system which anticipates creation and publishing of digital media files with a simpler interface than a monitor, mouse and keyboard, and can manage the entire workflow from the beginning of the creation process all the way to the point of publishing and notification.

### SUMMARY

The inventive subject matter generally relates to a system which combines many different previously independent technologies. These components are somewhat intertwined when establishing the described system, but can be logically separated into several distinct software and hardware components. The hardware components include a computer system for creation of digital media (“encoder”), a removable hardware component which provides digital information storage (“key”), a computer system (“media server”), which stores or streams digital media published to it by the encoder and provides it for presentation to users' viewers, and a generic computer network which connects computer systems (“network”). The software components include at a high level one or more operating systems (“OS”) which run on the “encoder” and “media server” computer systems, digital media creation software (“encoder software”) which runs on the “encoder” machine, automatically activated software for access of removable media upon insertion (“hotplug software”), network transfer software (“file transfer software”) which runs on either the “encoder” machine or the “media server” machine, and software which can provide access to digital media files (“media server software”) once stored on the “media server” machine.

Additionally, many of these software components can be implemented directly in silicon as hardware, such as the encoder software, so the logical breakdowns can be translated to different hardware and software combination implementations.

These and other embodiments are described in more detail in the following detailed descriptions and the figures.

The foregoing is not intended to be an exhaustive list of embodiments and features of the present inventive concept. Persons skilled in the art are capable of appreciating other embodiments and features from the following detailed description in conjunction with the drawings.

### BRIEF DESCRIPTION OF THE DRAWINGS

FIG. 1 shows a system and a method for capture and dissemination of digital media across a computer network according to the embodiments of the present inventive concept.

### DETAILED DESCRIPTION

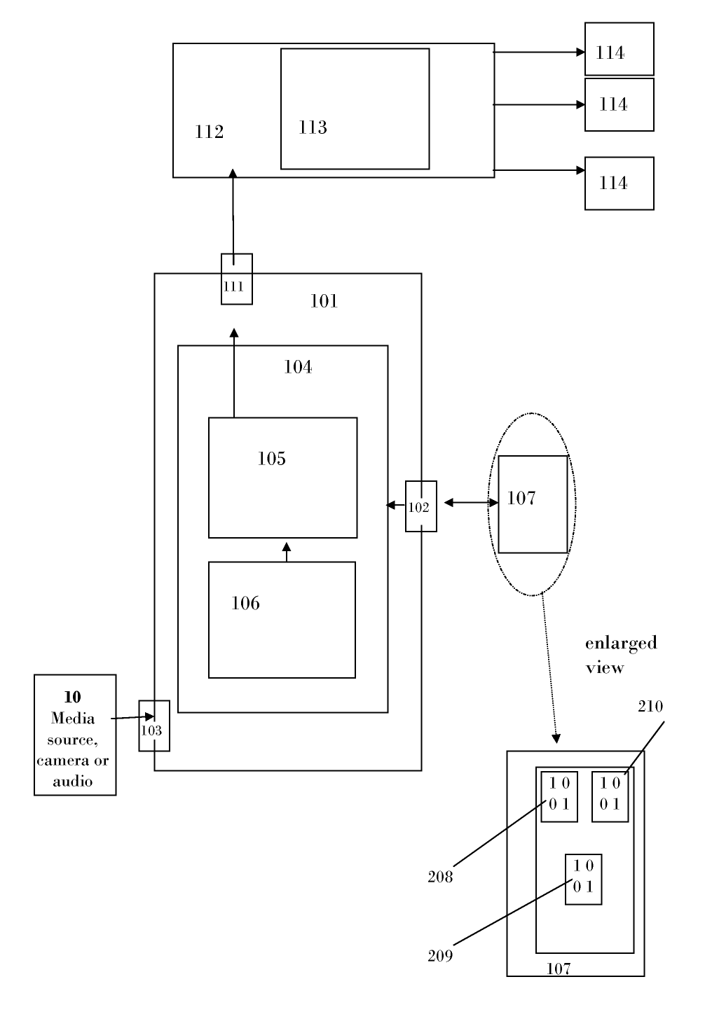

Representative embodiments of the present inventive concept are shown in FIG. 1.

The following is a list of the components that correspond to the reference numbers as indicated in FIG. 1. The illustrated system is an example embodiment and persons skilled in the art will appreciate from the teachings herein that variations are possible. For example, hardware and software components need not be under a single housing but could be distributed. Examples of ports, interfaces and network features could be selected from known alternatives.

“Encoder” Computer

(10) Media source is a hardware device that can be connected to a media encoder 101 for transfer of media represented as analog or digital data; the media source is typically a video camera or audio recorder, which stands alone for live capture and transfer to the media encoder, or, alternatively, may be built into the media encoder.
(101) Media encoder is hardware and software involved in the capture, creation and/or broadcast of digital media (may also be referred to as an “encoder computer”, “Webcast In A Box” broadcast video appliance, or “WIAB”)
(102) Hardware interface associated with the media encoder for removable media (e.g., a USB port)
(103) Hardware for conversion of analog media to digital media, plus software interface to component “101” (“audio/video capture card”)
(104) Software component(s) which may provide: digital media creation, optionally provides compression of digital media files, plus software program process for receiving “key” insertion and withdrawal (“hotplug”). Can be a single component, or broken into two or more separate pieces “105” and “106.”
(105) Digital media creation and optionally compression software. (“encoder program”)
(106) Broadcast delivery software component (“media server”)
   “Key” Removable Hardware Device
(107) External hardware component key with memory, which may be referred to herein as a “key”, “thumbdrive” or “SmartKey.” The key may be, for example, any removable flash, cartridge, hard drive, or optical disc-based storage device that can be used to transfer data between computers.
(208) File containing authentication passphrase (e.g., an XML file), optional
(209) File containing recipient list for messaging (e.g., an XML file), optional
(210) File containing network destination and/or other information, such as video capture parameters (e.g., an XML file), optional
   Network Connection
(111) Network hardware interface (e.g., an Ethernet port)
   Media Server
(112) Media server computer where some or all of the media captured by the media encoder 101 may be published for access by users via their viewers 114
(113) Media server software
   Viewers
(114) any device by which users can perceive published media in video or audio forms, the viewers including, for example, personal computers, cell phones, and PDAs.

Hardware Components

The encoder hardware 101 typically requires at the very minimum a computer system with a central processing unit, a network interface, analog to digital conversion hardware (if the media source does not itself provide a digital input), an interface 103 for accepting removable media storage hardware key 107 and a power source. The removable media key typically provides a writable storage media, and random access memory. These components are often implemented in the real world as a CPU chip, an Ethernet card (wireless or standard), digital media (video and audio, or audio only) capture cards, a USB or Firewire input jack, permanent memory storage in the form of a hard drive or writable flash memory card, one or more RAM chips, and a power supply, respectively. The digital media capture card often accepts s-video or composite video standard cables and standard ⅛ inch stereo input jack as inputs, but it can also accept pure digital inputs like Firewire cameras, in which case no analog conversion is required. There is generally a software layer in between each physical hardware component and then operating system, called a “driver,” and this is true for at least the removable media input jack and the media capture device.

The removable storage medium is generally implemented as key 107 that removably is inserted into an interface on the encoder. The key may be, for example, a USB or Firewire “thumb” drive, which is a small piece of hardware which often is carried on a keychain or in the pocket. These drives typically contain no moving parts and are able to store at least several megabytes of digital information. This storage medium typically requires no internal power as power is provided to the removable device from the encoder machine once the medium is inserted into the input jack on the encoder hardware device. The interface 103 is the corresponding port, such as a USB or Firewire port on or associated with the encoder.

The media server application typically will be implemented as a high powered computer 112 with high quality and high performance components that are not standard for a desktop computer. It will typically have a redundant hard disk storage system, such as RAID storage, attached. It will generally have a large amount of RAM, and will have a high degree of processing power. Of particular necessity is a network interface which provides massive data outbound throughput, and possibly high inbound data throughput. This currently would be supported by a 100 megabyte (MB) network card, or even a gigabyte (GB) network card or above. This computer will often have redundant power supplies to prevent downtime due to power failures.

The network required for this system can be a closed network, like a LAN on a corporate or educational network, or an open network like the commercial Internet. Generally this network will consist of routers, intermediate computers, and endpoint computers. The connection protocols used between the “encoder” computer and the “media server” computer are unspecified, but the most common protocol implementation will be TCP/IP. It will be the responsibility of the network drivers or the network card hardware to manage connections between these two machines.

Software Components

The operating system required for use in this system will need to provide at a minimum software interfaces (“drivers”) for all required hardware, including media capture devices, removable media input sources and network devices. It should support multiple simultaneous process execution (“true multitasking”). It provides a foundation of support for the network protocols for whichever network the system is deployed. Operating systems on which this system could be deployed include any of the different variants of the Linux operating systems which include either the 2.4 or 2.6 kernel, versions of Microsoft Windows above Windows 2000, and Mac OSX and above.

The digital media creation (“encoder”) software 105 will generally pull frames of video and/or audio data from the hardware capture devices indirectly through operating system software drivers. These drivers will translate analog images into digital frames which the encoder software can convert into a compressed form of video if the system requires compressed video like RealVideo by RealNetworks, Windows Media by Microsoft or MPEG4 by the MPEG Consortium, or audio like MP3, or it can translate the video frames into an uncompressed video or audio format like uncompressed AV1 or WAV. The encoder software will write this video data to the storage media, whether this is a hard drive or removable media like a flash card. The operating system will often provide drivers to access this media, and may also provide buffering and other assistance in managing the storage of the media file. A typical example of this software is RealNetworks “RealProducer” software which pulls video frames from video4linux drivers on the Linux operating system and converts those digital frames into the RealVideo video codec format.

The operating system should provide software 104 which is activated automatically a (“hotplug”) when the removable media hardware key 107 is inserted or removed. The hotplug software 106 should provide access to this process so that external software processes can be actuated upon initiation of this process. It may provide information, for example, about the type of event received, whether this be insertion, removal, and potentially availability of the removable hardware. It may also provide facility so that identification of the media inserted can be ascertained in the case of a system which supports multiple types of digital media. The operating system should provide software drivers so that the inserted media can be accessed and digital information can be processed and potentially copied. The Linux operating system provides this facility in the form of their “hotplug” software which automatically enables the capability to execute an external process upon insertion of a key 107, such as a USB thumbdrive, notifies the executed software process of the type of action and the location of the media through environment variables. The software process which runs upon insertion of the media device is the “hotplug activation program,” while the removal of the media executes “hotplug deactivation program.”

The digital media access software 113 (“media server software”) can be a web server which provides access to digital media files to different software running on a viewers computer 114 through a network. An example of this software is the Apache webserver which runs on both the Linux and Microsoft Windows operating systems. Specialized software called streaming media servers can also be used to optimize the experience for different accessing software. Examples of this streaming media software include RealNetworks “RealServer” or Microsoft's “Windows Media Server.”

Software Process

The system process begins with the insertion of a removable media device 107 into the encoder machine 101. After the user of the system inserts a key 107, such as a “thumbdrive”, the system recognizes this insertion. The operating system software then starts the “hotplug” software process, which mounts the “thumbdrive” and executes the “hotplug activation software,” providing it with information about where the “thumbdrive” is available within the operating system interface and that this action is an insertion. The system then reads information provided on the “thumbdrive” and optionally writes some of that information to the “encoder” computer system. This can include authentication information, which could be used to verify that the user of the system has permission to utilize the system. It can also provide notification information over email or other mechanism to indicate to an administrator that any stage of the process has completed. The “thumbdrive” can also store metadata about the event, such as title, description, author, and other information specific the event. One example of this could be to store a formatted text file on the “thumbdrive” as XML (eXtensible Markup Language), or another standard format of text file. The benefits of using a standard format of text file are that various software can be used to generate and validate this file. The encoder system 101 could retrieve this file from the “thumbdrive,” read the file to determine the validity of the user, and then store this information on the “encoder” system for later use.

The following is one example of an XML file storable on the key 107:

<opt author=“ foo@foo.com” description=“This is some podcast”
title=“Podcast by me”>
<upload>
<protocol>ftp</protocol>
<username>joe</username>
<password>123abc</password>
<host>tolstoy.meedu.org</host>
<path>abc/def</path>
</upload>
</opt>

Additionally, the key may store other data. For example, data for hardware or software controlled video capture parameter, such as: video dimensions, video bitrate, video version, input source (s-video or composite, for example), remote capture source, video crop information, watermarking image.

If the hotplug “activation” program cannot determine where to find this XML file, or cannot determine proper credentials for the user who inserted the “thumbdrive” then the process is aborted. If the system has a method of notification for the user, the user will be notified. This could include printing information to an attached LCD (liquid crystal display) or it could involve audible signals using the computer's system bell.

If the “activation” program does not require authentication information on the “thumbdrive” or it is successful in retrieving and verifying this information, then it can activate the “encoder” software. The “activation” program will start the encoder and begin the process of creating a digital media file, or archiving a file by retrieving media from a pre-existing capture session executing independently. This process will continue without interaction from the “activation” program, and the “activation” program can therefore complete after it has started the “encoder” software.

Once the user has decided that the event is completed, they can withdraw the “thumbdrive.” Withdrawing the “thumbdrive” results in execution of the “hotplug deactivation program.” The “deactivation” program halts the “encoder” software and signals to the “encoder” software to write the digital media file to disk if it has not done so already. At this point the encoder system can also perform post-processing on the file if necessary, such as generating a searchable index within the media file. The “deactivation” program then can optionally notify the user that this process has completed via audible or visual signals on the “encoder” computer. Optionally, the “deactivation” program can store “metadata” information about the event. This information can be incidental to the event, like data and time, or specific to the removable media and contain information that would distinguish it from different “thumbdrives,” or generic and associated with the encoder machine itself.

After the digital media file has successfully written the digital media file to the “encoder” computer's storage, the “deactivation” program can optionally start the “file transfer” software and begin to publish the digital media files, in whole or part, to the remote “media server” computer. It is desirable, however, that this process occur in an asynchronous manner due to the fact that the “media server” computer may be temporarily unavailable related to network conditions or otherwise. Therefore, it is preferred that when the digital media creation process is completed that the “deactivation” program complete it's processing while providing stateful notification to the “file transfer” program such that it can operate independently of the state of the “encoder” system. This means that the “deactivation” software must record in persistent storage the distribution state of the file transfer. This will typically be implemented as a file with state information, or in a database which stores that same state information. If the “encoder” system is used to create multiple media files upon each insertion of the “thumbdrive” then there will need to be state stored for each of the media files.

Once the “deactivation” program has stopped media capture, an asynchronous process should begin to attempt to transfer the media files to the “media server” computer over the computer “network.” This “file transfer” program can optionally retrieve connection information which came originally from the “thumbdrive” and was stored on the “encoder” computer and is therefore unique to each digital media set of files, or the “encoder” computer can store connection information regarding all media created by that machine. If the “media server” is inaccessible, the “file transfer” program should reattempt later. When the “file transfer” program finally completes upload of the digital media files, it should indicate this by setting a status association to those files. Often this file transfer program will utilize transfer protocols like FTP or SCP. Bindings for these protocols exist in many programming languages, like Perl/Python/C#/Java, so it should be possible to implement this program in any of these languages.

The media server will be used by both clients of the media (users) and producers of the media, which means that an administrator will optionally desire to implement a security protocol. Typically, security should be implemented to the highest standards, using SSL, public/private key authentication, or one of many other encryption schemes to transfer and transmit data between components in the system. It may also be worthy to build a custom authentication scheme on top of these tried and tested authentication schemes, so that by merely breaking into the first layer of security does not allow compromise of the total system. It is important to note that a layered authentication scheme is the best solution; the more standard an encryption scheme, the more likely it is that it has been tried and tested to survive attacks, but at the same time, a custom encryption scheme will be harder to break in that public information about break ins are less likely to exist. A combination of these two approaches will lead to the best security for the overall system. For example, one implementation could be as follows: a media encoder and media server could communicate over industry standard SSL encryption to send files back and forth. In order to communicate with the media server, the media encoder could be initially configured to use a random and unique string that is generated on the media server. When the encoder generates a media file and attempts to transfer it to the server, the server could first respond by requesting the registered random string in order to validate the request. This would mean that even if a break in occurred on the media server whereby the SSL encryption was compromised between the two hosts, that it is unlikely that the break-in perpetrator would know how and where to retrieve the random strings sent back and forth, and would therefore be unable to publish files that would reach a public user of the system.

Once the files have successfully been transferred (which is considered “publication”) to the “media server” users can access these files via viewers 114. A web server or a streaming media server can provide access to many different types of media player programs.

The system 101 may also, optionally, write data on the key 107. For example, the system may write a copy of the captured digital media file or data about the capture or broadcast event associated with the file, or it may store logging and debugging information about the process so that a user can troubleshoot if necessary

User Manual For Exemplary System

The following material is from a user manual for a commercially available embodiment of a system according to the inventive subject matter described herein. The system is available from Webcast in a Box, Inc. of Portland, Oreg. (www.webcastinabox.com). The material elaborates on the inventive subject matter disclosed above and disclose additional inventive features.

Introduction

Webcast In A Box is video broadcast appliance for computer networks. It allows you to encode and stream two synchronized, digital video channels simultaneously—video from a video camera, and video from a computer desktop display. You can lay out these two channels as a live presentation and personalize or brand presentations with a background color, background image, logo, and/or a banner. The complete presentation is viewed in the standard RealPlayer from RealNetworks, Inc., which is available on Microsoft Windows (tm), Apple Macintosh (tm), Sun Solaris (tm), Linux and other operating systems.

Hardware

Webcast In A Box includes a power cord, audio/video input jacks, and ports for network connection. You supply power, audio/video devices and cables, a video scan-converter (if your computer doesn't contain one), and a network connection cable. The built-in audio/video inputs are standard composite or s-video jacks for both physical channels as labeled on the back of the unit. Network connectivity can be achieved by plugging into the “1 GB” jack as labeled on the back of the unit. Network connectivity will match your capabilities be they 1 GB, 100 MB, or 10 MB speeds. Webcast In A Box does not require a monitor, mouse, or keyboard.

Operating Components

There are four major distinct components engaged in any webcast using a Webcast in a Box appliance: a Webcast in a Box appliance with camera, viewers using their own computers, a presenter with an optional laptop, and an optional Mothership Webcast in a Box Appliance. The normal operation of the appliance is to use the WIAB appliance with a camera attached to one video input, the presenter's laptop connected to the other video input, with several viewers watching the broadcast using the RealPlayer directly connected to the WIAB appliance media server. If you decide to broadcast only the speaker presenting using a single channel of video, the laptop video source can be removed. If you are in a situation where the broadcasting location has low bandwidth, you may opt to use the WIAB appliance as a satellite appliance and broadcast into a high bandwidth location provided by a Mothership WIAB appliance, described in more detail below.

Usage

You can operate the Webcast in a Box simply by plugging in a USB SmartKey drive to start a webcast and then stop it by pulling out the drive.

Webcast In A Box displays its IP address in the LCD display on the front of the unit. Type this address into any browser on any computer that is on the same network as the unit and you will be able to perform all system operations from a simple, Web-based interface.

Webcast In A Box allows you to start broadcasting with a single click on the Welcome page of the Web interface. You can also schedule an event and create/choose a custom layout template for your webcast using the web interface. Your viewers can access the webcast from a Web link that can be emailed as an invitation to join the webcast. All webcasts are archived and viewed on demand using the same link.

You may export a webcast including the video files, the graphics, and the SMIL files that provide the synchronization and layout for the webcast. Exported files can be moved to an external Helix server or to a local file server or burned to a CDROM for portable playback.

Positioning

For conference room or classroom broadcasts, Webcast In A Box recommends that the appliance be placed near the computer of the webcast presenter. This enables a simple connection between the presenter's machine and the video input on the back of the unit.

Scan Converter

A scan-converter should be used to convert and improve the VGA signal from the computer into a composite video signal that is plugged into the back panel of the appliance. However, many new portable computers now have built-in, video-out capabilities. Video directly from a camera, a video conferencing end-point, or signal mixing board can also be plugged in the back panel of the unit for the purpose of broadcasting video of the presenter.

Video Inputs

Webcast In A Box accepts composite or S-video input. Use the provided RCA plug (yellow) for video input. Webcast in a Box does not use the audio interfaces on the Osprey capture cards for audio capture. Use a y-adaptor to join the signal into a RCA jack and plug it into the blue port on the sound card to the left and base of the capture cards.

Network Interface

Webcast In A Box comes with two network interface plugs for both 100 MB and 1 GB connectivity. Use the 1 GB connection for normal use on any speed network from 1 GB to 10 MB. This interface will attempt to bind to an address via DHCP upon first use and until the administrator sets a static IP address for the system. The 100 MB connection is used for system administration purposes only and should not be used to view video or generate profiles.

Power

Use the provided standard computer power cable for power to the unit. Power surge protectors and power back-up systems are recommended. Webcast In A Box systems can be safely unplugged or turned off after use, however it is recommended that you use the full shutdown process as detailed on page 18 when possible. A complete system power-up and initialization cycle normally takes about 60 seconds. The system is ready when it displays its IP address in the front LCD panel.

Network Settings On DHCP Network

If you plan to use the appliance on a DHCP (dynamically assigned IP address) network, you can plug a network cable into the network port in the rear of the appliance marked with a “1 G” for Gigabit.

Network Settings On A Static IP Network

If you plan to use the appliance with a static IP address, you must configure the appliance for the proper network settings with a laptop or desktop machine first.

Software License Agreement

When you use the system, and you have entered the IP Address (appearing on the appliance's LCD display) into your networked computer's browser address line, you are presented with a screen which allows you to easily generate a webcast. The first use of the appliance, however, requires activation. Click on the button which says “Producer Console,” and then accept the secure certificate. You are then prompted for agreement of the Software Licensing Agreement. After reading the license agreement, click “I agree” in order to navigate to the System Settings page for the system. This license message will only appear until the agreement is accepted.

USB License Acceptance

You can indicate acceptance of your software license by placing a file named “license.txt” alongside your wiab_settings.xml file with the text “yes” as the only contents. If the Webcast in a Box appliance sees this file it enables broadcasting without visiting the web interface acceptance page.

Initial Log-in

After accepting the License Agreement, you arrive at the Log-in page. Choose the username “administrator” username and enter the password “changeme” in order to enter the administrator section. You will change this password soon after logging in.

Popup Blocking Software

The Webcast in a Box web interface relies heavily on the use of popup windows. Please disable popup blocking software before using the web interface. You will see a message notifying you of this any time you access the site with a web browser which has never been used with the Webcast in a Box appliance software.

System Settings

Once you have entered the administrator section, click on the link on the left side of the page which says “System Settings.” On the System Settings page, you should immediately change the Administrator Password by updating the field named “Administrator Password” from the initial value “changeme” at the top of the form and clicking “Save Settings” at the bottom of the form. (You will then be returned to the System Settings page.) By clicking on any link you will be prompted for the new password; the old password will no longer work. Change the “Producer Password” as well. The producer password provides limited access to the system for the purpose of scheduling and operating webcasts without the ability to access the System Settings page.

Help Tips

In many places throughout the web interface you will notice small question marks (“?”) adorning the text of different settings and controls. This indicates a help tip. If you click on this “?” link, you will popup a window with more information about this feature.

Logging

All processes on the Webcast in a Box appliance are logged. If you ever feel that something is in error, check the log files by logging into the web interface and clicking on the “Access Logs” link. Modules are a way of breaking different process logging into smaller files, so choose the appropriate module, select the date, and then choose whether you want to see regular events or errors. The “global” module provides all events for the entire day. If you cannot determine how to resolve a problem on your own, you should send the global log file to support@webcastinabox.com for assistance.

Administrative Configuration

Security

System Settings and Network Settings both appear as choices on the Main Navigational Menu only when you have logged in as an administrator. If you do not see this link, please click “Logout” and log back in as an administrator.

Network Settings

The Network Settings part of the administrator section allows you to establish network related settings. Generally you will access only the most common settings, but if you need to access advanced settings, click on the link “Advanced Settings” underneath the “Network Settings” heading. To go back to the common settings, click on the “Simple Settings” link.

DHCP IP Address

The Webcast in a Box system will automatically attempt to bind to a DHCP address when plugged into a network for the first time. The IP address can be determined by looking for the “IP Address” displayed in the LCD.

Static IP Address

If you need to specify a static address, click the “Adjust IP Settings” button, deselect “use DHCP” and enter valid network information. Be sure to click the “Store Settings” button to establish the new network settings. Verify the IP is correctly displayed on the LCD of the machine.

LCD Network Information

Once you have placed your Webcast in a Box appliance on a network, you will see networking status information displayed in the LCD. If you see a “(G)” on the top row of the status, this means the device has found an IP address or has been configured properly for an IP address and is bound to the Gigabit interface. If you instead see a “(M”) this means the machine could not get a dynamic address. In this case, you should either use the 100 Mbit interface with a crossover cable to configure a static IP, or you may need to register the MAC address of the gigabit card for use on your network if MAC filtering is used. The “S” indicates that you have established a static IP address, while a “D” indicates a dynamic (DHCP) address. Pay special attention to the information presented with the “Gateway” status. If you see a “*” in front of the “Gateway” address this indicates the appliance cannot reach the gateway (via “ping”) and you may need to confirm your network settings, or verify your network cable is working properly.

Multicast Exclusion Lists

The Webcast In A Box appliance is ready to broadcast on a multicast network right out of the box. By default, the Webcast in a Box appliance will attempt to deliver its broadcast over the multicast segment. However, if there are certain IP subnets which should or cannot receive a multicast broadcast then the “Multicast Exclusion List” can be used to exclude users on certain subnets so they receive unicast streams. Enter network block values, optionally using a “*” to designate wild card values, and click the “Add” button. For example, to enable a client with the IP of 10.10.10.43 to view with a unicast stream, enter the value “10.10.10.*” which will provide unicast streams for anyone with an IP address that begins with “10.10.10.”. You may remove an address by selecting it and clicking “Remove”. Settings will not be saved until you click “Submit Changes” on the bottom of the form. If you want everyone to receive a unicast stream, add “*.*.*.*” to the list, click “Add,” and then save the settings by clicking “Save Settings.” This is the default setting, so if you want to provide multicast access you should change this setting.

Mail Server Host Information

This value stores the SMTP server that is used to relay outgoing email messages when webcasts are started using the USB SmartKey feature, or when an operator manually sends announcements. If the SMTP host requires a username and password you can enter this information here as well. Once entered you can test the values by clicking the “Test” button to the right of the input field.

Database Connection

The Webcast in a Box appliance ships with the MySQL database. If you wish to manage the database on a remote server, the “Database Connection” field can be used to configure an external database. You will need to populate the remote database with the proper table structure in order for the Webcast in a Box appliance to properly use your remote database. Please contact Webcast in a Box for more information at support@webcastinabox.com. The Webcast in a Box system ships with database drivers for MySQL installed; if you need drivers for Oracle, Postgres, or any other database, please contact Webcast in a Box.

Streaming Server

The Webcast in a Box appliance has a fully licensed, unlimited unicast and multicast stream Helix DNA streaming server on board. You can serve almost an unlimited number of clients from your server within a corporate or educational LAN network directly from the Webcast in a Box appliance. If you would prefer to use a remote streaming server, and have the appliance operate as an encoder only, you can enable this functionality under the “Streaming Server” section. Deselect the box “Use Local Streaming Server” to display the settings for the remote streaming server. Enter connection information in this format: username:password@host[:port]/filename. A sample therefore might be webcast:test@199.199.199.199:4040/remote.rm. For protocol, select “G2” if you are using an older G2 streaming server, or select one of the newer protocols if you have a supported Helix Server 9 or above. If you wish to use one encoder locally and one remotely, use the string wiab@localhost:30010/speaker.rm for the speaker (channel 1) or wiab@localhost:30010/desktop.rm for the desktop (channel 2) with the protocol set to “G2.” You can also enable the Webcast in a Box appliance to act as a satellite encoder working in tandem with a mothership server.

Remote Archive

The Webcast in a Box appliance has a 200 GB hard drive which is large enough to store 1000 hours of video at default bitrates. However, if you wish to move content produced by the appliance to a remote server after a webcast has completed, or once the appliance is placed on a network, you can use the “Remote Archive” feature. To enable this feature, uncheck the box “Use Local Archive.” Then, enter host, username and password, remote path information and protocol as either FTP or SCP.

Save Settings Button

You must click the “Save Settings” button when you have changed settings or your settings will not be saved. If you don't click “Save Settings” and then close the web browser, or click on another link in the navigation bar, you can leave existing settings as they were before modification. If you click “Store Settings” you will see a message indicating the settings have been stored successfully if settings were properly saved.

System Settings

Webcast In A Box Administrators can modify system settings by clicking System Settings on the Main Menu of the Web-based User Interface.

Administrator and Producer Passwords

Set the passwords used by the administrator and producer here.

Enable FTP

Administrators may enable and configure the built-in FTP server by filling out the username and password values in the Enable FTP section. After the changes have been submitted, the user can access and upload files on the system by clicking the “Archive Folder” or “Customization Folder” links and simply dragging and dropping files from and to the folder.

Video Input

Choose from S-Video or Composite input here. Webcast in a Box recommends S-Video for the best quality video whenever possible.

Announcement Text

Whenever a potential viewer of a webcast is notified via email from the Webcast in a Box appliance, the text in the “Announcement Text” section is used. This can occur when an administrator clicks brings up the announcement console (shown on left), or when a USB SmartKey webcast is started and an email.txt file is used to notify viewers. You can customize the message with several “placeholders” which are replaced when the actual email is sent: %RELATIVE_URL% (a relative URL to the webcast, useful if your server is mapped in DNS and you want only the URI to the webcast, “/4.ram” for example), %URL% (the full URL to the webcast, http://192.168.1.100/4.ram for example), %TITLE% (the title of the webcast), %DESCRIPTION% (the description of the webcast), %DATE% (the date the webcast is scheduled to start), %HTML_TITLE% (a hyperlink to the webcast with the title as the text, ‘<a href=“http://192.168.1.100/4.ram”>Title</a>’ for example).

Default Settings

Select the default webcast profiles here. These settings are used whenever a webcast is created with the “Quick-Start” links or from a USB SmartKey webcast.

Default Archive

Select “Yes” if you want all webcasts created using the “Quick-Start” link or USB SmartKey webcasts to be archived on disk after the presentation. If you want to provide only the live stream with no archive, select “No.”

SmartKey Secret Phrase

Set the secret phrase which is stored in the key.txt file on the USB SmartKey.

SmartKey Email

This is the email address used in the “From:” header when a USB SmartKey webcast is announced.

Save Settings

To save your settings, you must click on the “Save Settings” button. If you do not wish to store edited settings, you can close the web browser or click on another link in the navigation bar to ignore all changes.

Restore Settings

This allows you to restore the Webcast in a Box settings to the default settings when the machine was shipped. If you misconfigure the appliance and cannot remember the original settings you can always recover by clicking this button. All customized settings will be lost.

Server Restart

Administrators may also reboot or shutdown the system from the Administration page. Simply unplugging the system is safe, but shutting down the system through the administration page may prolong the life of the appliance and may reduce the time required to initialize the system.

Update

You can update the software on the appliance by clicking on the update button. You should not do this while the appliance is live and be aware that this process may take a short while as new software is downloaded and installed. You should reboot the appliance after this process is completed. If you ever see a feature listed in this Administrator Guide which is not available on your Webcast in a Box appliance, you probably need to update your box to the latest version by clicking on the “Update” button.

Update Components

Certain components are not installed by default on the Webcast in a Box appliance. You can choose which components you would like to enable by clicking the “Update Components” button. This will popup a window allowing choices over several components.

Clean System

You can clean the machine, choosing to delete archives, log files, or statistics. Be aware that these operations are irreversible; if you delete all archive files there is no way to recover these files later.

Webcast In A Box lets you quickly and easily start a webcast. The “Start Broadcasting” button on the Welcome page will immediately create a new webcast with the current time and default settings, and start broadcasting. The broadcast will use the webcast profiles that are specified in the “Default Settings” item on the “System Settings” page. You can also generate a new webcast by clicking on the “Quick Start” link in the navigation bar on the left. If you create a webcast using the “Start Broadcasting” link on the initial entry page the webcast is generated and started. If you create a webcast using the “Quick Start” link, the webcast will be created, but will not be started automatically.

Operator Console

Immediately after creating a webcast using either of these two methods, the Operator console will be displayed. This console contains Channel Status, “Start”, “Stop”, and “Announce” functions and a link to adjust the audio levels of both channels.

Channel Status

The presenter video channel and the desktop video channel each have status indication at the bottom of the operator window. If a channel is idle you will see text stating “idle.” If a channel is live, you will see links to all possible permutations of the stream listed as hyperlink URLs. You can test all URLs to streams from within this console. If you are using the local streaming media server, you will see links to each individual unicast stream, each individual multicast stream, the presentation URL, the live link, and the full presentation served over both unicast and multicast. This allows you to start a webcast and verify that all links are valid before sending out an announcement email.

Start Webcast

If your webcast is started automatically, you will see status messages toward the bottom of the Operator console indicating so. If you need to manually start a webcast, click the “Start” button. You will then see a sequence of messages in the bottom of the window indicating that the system is initializing, and finally see status on the live webcast.

Stop Webcast

Once you are finished with the webcast, you can stop it with the “Stop” button. You will then see the encoders halting and the channel status will display “idle.”

Send Announcement

When you choose “Announce,” the Announce window pops up allowing you to enter to whom the webcast will be announced, from whom the webcast is generated, a subject for the email, and an announcement message. A default message for the body of your email invitation can be created on the System Settings page in an area called “Announcement Text.” When you click the “Send” button an email is sent to your specified viewers/invitees with a link to the current webcast.

Disabling Automatic Stop

If you have scheduled a webcast to automatically stop (you can disable automatic stop by clicking on the link “Disable Automatic Stop” underneath the start, stop and announcement buttons. If you do this, you will need to stop the webcast manually using the operator console.

Prepare Webcast

You may schedule an event by clicking “Prepare Webcast” on the Main Navigational Menu, and filling out the form with the event title, description, time, duration, webcast profiles, archive, activation type, and operator email address. Review the help tips by clicking on the “?” symbol if necessary.

Archiving

The “Archive” radio button indicates whether the webcast should be archived for subsequent on demand playback or replay of the webcast.

Activation Type

Scheduled webcasts can be automatically activated by choosing “Automatic” from the “Operate” field. This enables completely unattended webcasts of regularly scheduled meetings or conferences. Webcasts can be automatically started and manually stopped, or both started and stopped manually.

Operator Email

Enter your email address into the Operator Email field. If other users attempt to schedule a webcast at the same time or if they want to ask questions about the webcast this email can be used to contact the operator who created this webcast.

Submitting the Request

Click “Submit New Webcast” when the form is complete. You can subsequently edit the values of the webcast by clicking the “Edit” action for the webcast from the Program Guide. Webcast In A Box will verify that the time slot requested is available. If there is a conflict then you will be notified as such and provided an opportunity to mail the person who set up the conflicting webcast.

Operating the Webcast

Once you have scheduled a webcast, it will be displayed in the program guide. To operate it, click on the “Program Guide” link in the navigation bar. Then, find the row with the webcast you wish to operate, and underneath the “Action” column pulldown and select “Operate.” Then, click “Go.” This will expose the Operator console which allows you to start, stop, announce a webcast. You can also adjust the audio levels for each channel using the audio link (on right). If you have scheduled a webcast for automatic start or stop, you can also disable automation by clicking the link provided.

Restarting a Webcast

Once you have stopped a webcast, you can always restart it with the start button, if desired. This is useful if you need to first test settings of the webcast, check live links, and then stop until the proper time for the actual webcast. The archived webcast uses the last generated files, but the system does not delete any files created unless you explicitly ask it to. If you accidentally click start again after creating a webcast, you can always retrieve and restore the original webcast later by replacing the correct files. Contact Webcast in a Box at support@webcastinabox.com for assistance if this is the case.

Automatic Refresh

If you stop a webcast and do not close the operator console, you might notice that when another webcast is started from another machine or with a USB SmartKey that the operator console automatically refreshes and displays the status information for any webcast. You cannot stop, however, this new webcast with the same operator console. This is to prevent someone from accidentally stopping a webcast they don't realize has been started by another operator. If you really need to stop this webcast, click on the “live” links underneath the navigation bar, and then click “Stop” from there.

Logging

All requests for webcasts are logged, so please check the log files under “Access Logs” in the navigation bar. Most information related to webcasts are logged under the “web-admin” section.

Editing Webcasts

After you have prepared a webcast, you can edit it to change settings. Click on the “Program Guide” in the navigation bar on the left of the web interface. Determine which webcast you want to edit, and select “Edit” and then click “Go.” If the webcast is still pending, you can change the title and description, adjust the webcast profiles, change time and duration, or adjust any other settings. Click on the button marked “Submit Changes to Existing Webcast” in order to save your changes. If your webcast is in archive you can edit the in and out points of the video using the video editor.

Video Editor

If your webcast is in archive, you can use a graphical editor to adjust in and out points. From the “Program Guide” find the webcast you wish to edit. Select “Edit” from the “Action” list, and click “Go.” The video will play from the beginning of the video. As the video progresses, you will see time in milliseconds of the video displayed in the “Current Video Time” field. When you have found the correct in-point of the video, click the “Set” button under “Video Intime.” When you have found the correct output, click “Set” under “Video Outtime.” You can set both the in and out points, or one or the other. If you want to review your positions, move the slider underneath the video, or click one of the “Go” buttons. Once you have finished, click “Update Offset Times” to establish your settings in the editor page. Then, make sure to save your settings by clicking the button labeled “Edit Webcast.” You must be sure to click the “Update Offset Times” button, followed by “Edit Webcast” or your settings will not be saved properly.

Usage

The FTP server is used to upload files for customization or for download and mirroring of webcasts stored on the server.

Customization Access

The FTP server permits an administrator to upload files to the system with a username and password. You can specify this username and password when you choose to enable FTP in the “System Settings.” The customization folder is used to simply modify and augment parts of the Webcast in a Box system.

Audience Folder

The folder marked “audience” contains RealProducer Audience Description (RPAD) files which are used by the RealNetworks Producer Encoder software. These are XML files which specify bitrate, framerate and codec settings, among other things. The Webcast in a Box appliance ships with many different encoder profiles, but if you have a special need for different settings, you can upload new audience files via the FTP server. Refer to documentation on the RealNetworks website for more information on RPAD files. If you choose to upload files, they will be sorted and displayed in the “Audience” chooser based on the filename. Please name your files using the format name-version-bitrate-flow.rpad, where name is a mnemonic for display, version is either “rv8” or “rv9” indicating RealVideo 8 or RealVideo 9, bitrate is the bitrate of the audience file, and flow is either “cbr” or “vbr” for constant or variable bitrate. For example, a file name “My_new_High-rv8-10000-cbr.rpad” would be displayed in the RealVideo 8 section as “My new High” If you don't follow this format, you cannot use your RPAD file as a SureStream source. Please note that the Webcast in a Box system does not verify your settings inside the RPAD file match your filename, so you can cause encoding failures if you were to mix RealVideo 8 and RealVideo 9 audience files and select them for a webcast profile.

CDROM Folder

The folder marked “cdrom” contains files which are copied into each webcast directory. The sample files which are provided in this directory can be burned directly to a CDROM and will provide “autorun” functionality when the CDROM is inserted into a Microsoft Windows (tm) operating system. If you want to customize the behavior of the CDROM, please edit the file autorun.inf with this folder, or upload an entirely different set of files.

Import Folder

To import webcasts created on another machine into the Webcast in a Box appliance requires a FTP server. If you don't have an FTP readily available, you can use the Webcast in a Box appliance as a substitute. The import folder can be used to store webcasts for import.

Missing Folder

If a user accesses a webcast which is not available on the Webcast in a Box appliance, due to deletion of the webcast or an incorrect URL, they will always receive a presentation informing them that the webcast requested is unavailable. To customize this message you can upload a missing.smil into the missing folder. This file may not reference other files within the missing folder, but it can reference other media hosted on other sites. The missing.smil file can also contain “inlined” media, media which is stored as Base64 data directly within the SMIL file. The default missing.smil has inlined media. To create this you can use a tool built with the Perl programming language module Smil.pm from http://webiphany.com/perlysmil or contact Webcast in a Box for more information.

Style Folder

You can customize the layout and design of the Webcast in a Box web admin interface. Upload a new logo jpg or a modified version of the main.css file to modify the default logo or styles.

Templates Folder

You can create profiles for use when creating webcasts by uploading a template set into the profiles folder. You must place the set of files into a new directory within this folder, and you must provide at a minimum the following set of files: archive.smil, unicast.smil, multicast.smil and preview.html. These files should reference media streams called speaker.rm and desktop.rm for channel one and two, respectively. The SMIL files can reference other media, like background images within the same directory, or files from remote servers. All files from the template set you upload are copied into each new webcast.

Archive Folder

The Archive Folder is accessible over anonymous FTP when the FTP server is turned on. It contains subdirectories for each archived presentation that contain video files, SMIL files, and images if any were included in the presentation template.

Overview: Satellite and Mothership Operation

Webcast in a Box appliances can be tethered together so that one machine can act as a central repository for content created by other remote appliances. The central repository appliances are referred to as “mothership appliances”, and the remote appliances are referred to as “satellite appliances”. Multiple satellite appliances can all operate with a single mothership appliance simultaneously without interfering with each other, and different viewers can watch different live and archived content simultaneously without interfering with each other.

Usage Scenarios

Low bandwidth broadcasting environment: The mothership/satellite combination is useful when you are in a location where your outbound bandwidth is not great enough to support the number of viewers you expect, but you have enough bandwidth to provide a single outbound presentation stream (meaning both video channels for a single presentation). A mothership server should be co-located in a facility which can provide bandwidth for all viewers, such as a datacenter on a high capacity network. The satellite then broadcasts a single stream into that mothership appliance. When the broadcast is live, all viewers connect directly to the mothership appliance and are not aware that the content is created by the satellite appliance. Once the broadcast has completed, the Webcast in a Box appliance will upload and update all media files created for the presentation to the mothership appliance. After this process has completed, the satellite appliance can be unplugged and viewers can still watch the archive off the mothership appliance without any reliance on the satellite appliance.

Offline content creation: Satellite appliances can also be used for offline content creation, where an operator can use the satellite appliance without a network and generate a presentation, such as might be the case with a professor using the appliance at a vacation home without a network connection. Upon returning to campus, the satellite appliance is reconnected to the network. When the satellite appliance senses establishment of a network connection, it will automatically publish the presentation onto the mothership appliance.

Technical Details

Mothership and satellite appliances communicate via SSH to transfer media metafiles and establish communication channels. Media encoders send their data to the Helix DNA Server using the RealNetworks proprietary communication standard.

Satellite and Mothership Configuration

Communication between mothership and satellite appliances requires that both appliances are properly configured with a SSH public/private key. Follow these steps to create and install a WIAB/SSH key. In this example, we assume the satellite appliance is named satellite.webcastinabox.com and the mothership server is named mothership.webcastinabox.com. You should not use these hostnames but instead determine your own hostname or use numeric IP addresses.
Your mothership server should be placed in the DMZ of your datacenter network. Satellite appliances need to send data to the mothership server over the standard SSH port, as well as a range of ports for Helix encoders (30000-30200). In addition, clients watching the broadcast need to connect to several ports on the mothership server, so it is best if this server is not behind any kind of firewall.
Satellite appliances can safely be placed behind a firewall, but should have ample bandwidth to go outbound with a single presentation stream. So, if your webcasting profile uses two channels of video each at 225 kbps, the outbound connection for the satellite appliance should be minimally 450 kbps. If you are broadcasting from a DSL or cable connection be sure that you are aware of the download and upload speeds since it is often the case that they are different; upload speeds are often vastly lower than upload settings, so be prepared to adjust your presentation profile settings accordingly.
Login to your satellite appliance from the web admin by entering the hostname satellite.webcastinabox.com into a browser and entering the password for administrator. Click on the “Network Settings” link in the navigation bar. Unselect “Use Local Streaming Server” if it is not already, and then enter wiab://mothership.webcastinbabox.com into both the speaker and desktop channels. You must enter wiab://mothership.webcastinabox.com into both channels even if you plan on broadcasting on only one channel. It does not matter what the protocol is set to in this case. If the satellite appliance is already configured for the wiab protocol, you may be ready to broadcast. You can test by starting a webcast and seeing if the “presentation” link in the operator popup provides a valid link to a presentation.
Now create a WIAB/SSH key pair. You must logon to the satellite WIAB appliance with a standard SSH client and run “/opt/wiab/custom/bin/generate_wiab_key” This script generates a SSH key suitable for use with a master server and uploads it to a FTP server for installation on a mothership server.
Once this is completed, you can install the key on the mothership server by logging into the mothership via SSH and running the following command: “/opt/wiab/custom/bin/install_master_wiab key” with the URL to the file you uploaded. This can either be a remote HTTP or FTP URL to the key file, or you can upload the key file to your mothership server (perhaps via SSH or by temporarily turning on the FTP server on the mothership) and provide a file:/// type URL.
Now, verify that the installed key works on both sides. From your SSH connection on the satellite appliance, run the command “/opt/wiab/custom/bin/install_satellite_wiab_key”. If you see the message “SUCCESS” you have completed installation of the WIAB key on both sides. If not, please review any error messages.
   Usage: Import Webcasts
   If a webcast was created on another machine but you would like to host the file on the Webcast in a Box appliance, you can import the webcast using the “Import Webcasts”feature.
   Import Sequence
1. To import a webcast, you must first host all the files on a FTP server so that the Webcast in a Box appliance can retrieve the files. If you don't have a FTP server available, you can use the one on the Webcast in a Box appliance. Please see the section marked “Internal FTP Server” later in this section for more information. You do not need to leave the FTP server running once the files have been uploaded; it can be turned off and the Webcast in a Box unit can still resolve files stored locally on the box.
2. Once all the files are available over FTP, you can schedule the files for import. Click on the “Import Webcasts” link in the navigation bar. Into the text field, enter connection information about the webcast, such as username and password, hostname, and the path of the webcast on the FTP server. For example, if your files are hosted on the host named “mediasrv” which requires username and password of “media” and “server” within the “media/32” directory, then you would enter the location of “ftp://media:server mediasrv:media/32” Notice that this “location” is slightly different than a typical FTP URL for use in a web browser in that you must specify a colon (“:”) after the hostname and before the directory. This is so that the Webcast in a Box can distinguish between directories such as “media/32” and “/media/32” If the files are all located on your local FTP server you can click the “Schedule Local Imports” button to automatically import those webcasts.
3. If you wish to enter multiple webcasts, separate them with a newline. When you are finished, click the “Schedule Import” button.
4. If the “locations” you provided were correct, they will be listed underneath the text area. If there were input errors, they will be displayed above the text area.
   Required Files
   To import files into the Webcast in a Box appliance you must have a file called archive.smil in the location specified for import. This file should reference files called either speaker.rm or desktop.rm or both. When the archive.smil file is uploaded, the references to speaker.rm and desktop.rm are fully qualified with the IP address of the machine and the proper directory in which they reside. You may also have background images or associated files which have any name. The references to these files are not modified.
   Internal FTP Server
   If you do not have a FTP to host the files for import, you can use the FTP server on the Webcast in a Box. First, turn the FTP server on, and then upload the files into a new directory within the import folder. You may immediately turn off the FTP server after the files have been uploaded, even if the files have not been imported into the Webcast in a Box unit. If the Webcast in a Box sees files coming from its own FTP server, it can resolve and find the files even if the FTP server is turned off, as long as the paths to the files are valid. Once the files have been uploaded via FTP, you can easily import them by clicking on the “Schedule Local Imports” button, which will automatically discover webcasts loaded into the import directory via the FTP server.
   Logging
   All stages in the import sequence are logged in the “import” section on the “Access Logs” page. If you cannot import a webcast, check the log files for more information.
   Webcast Links
   The Webcast in a Box appliance supports several links to live and archive broadcasts. Depending on the situation and configuration of the appliance, you can use different links to present webcasts to your viewers.
   Standard Webcast URL
   Each webcast receives a unique numeric ID. This ID can be used to generate a URL to view the webcast. The URL is generated by tacking on a “.ram” extension to the ID, and prepending the host IP. For example, if the webcast numeric ID is 4, and the IP is 192.168.1.2, then the webcast URL will be “http://192.168.1.2/4.ram” This URL is valid for both the live webcast, and is also valid for the on demand archive webcast as well. So, if you create a webcast and provide both live and archive access to it, you can provide your viewers with this type of link and they will see the live event if they tune in during the live broadcast, or the archive link if they watch it later.
   Live Webcast URL
   The Webcast in a Box appliance always provides a “live” URL which can provide access to any currently live broadcast. The URL is composed of the IP address plus “live.ram” (for example, “http://192.168.1.2/live.ram”) This is useful if you wish to place a link to the Webcast in a Box appliance on an external server which always provides access to any currently live presentation. This URL is only valid if the machine is powered on and attached to a network however, so this URL should not be published if the machine is often in transit, or is not always left powered on. If the box is powered on, but no webcast is currently in progress, viewers will receive a message telling them to check back later.
   Secondary URLs
   When a viewer accesses a URL with their web browser (Internet Explorer or Firefox, for example) they receive a RAM file from the Webcast in a Box appliance. This is a text file which tells the web browser to launch the RealPlayer and provide the RealPlayer with this RAM file. The RAM file provides a secondary link to content which is used by the RealPlayer. Each live webcast will generally have a unicast presentation link, a multicast presentation link, and an archived presentation link. The Webcast in a Box appliance dynamically determines which link to send to the viewer based on the multicast exclusion list and whether the status of the webcast is live or in archives The direct links to these presentations will be the IP address, an archive mount point, followed by the webcast numeric ID, the type of presentation, and the SMIL file extension. For example, if the IP address is 192.168.1.100 and the webcast ID is 4, the unicast presentation URL would be http://192.168.1.100/archive/4/unicast.smil, the multicast URL would be http://192.168.1.100/archive/4/multicast.smil, and the archived URL would be http://192.168.1.100/archive/4/archive.smil. You can place these links inside of your own RAM files for hosting on external servers. However, once you do this, you lose the ability to automatically generate the proper URL for your viewing clients based on the settings stored on the Webcast in a Box appliance.
   Channel Status Links
   The “Channel Status” display in the operator console (shown at right) provides links to all the possible URLs available to a viewing client. Each channel has a direct unicast and multicast link which can be used to view the video from that channel only, either over a unicast connection or on multicast. The “Presentation” link is the “Standard Webcast URL” mentioned above, for example, http://192.168.1.2/4.ram. The “Live” link points to the “Live Webcast URL” mentioned above, http://192.168.1.2/live.ram, for example. The “Unicast” URL points to a RAM file which directly accesses the unicast stream full presentation (both channels within SMIL) at http://192.168.1.2/archive/4/unicast.ram, while the “Multicast” link. If you are using the appliance either as an encoder for a remote server, or as a satellite appliance, the links provide will be slightly different.
   Remote Server
   If you choose to host your streams from a remote server and use the Webcast in a Box appliance as encoders only, there will not be test links provided in the channel status since the Webcast in a Box appliance will be unaware of the final URL format.
   Configuration: Remote Streaming Server
   To use the remote server settings, go to the “Network Settings” in the navigation bar and deselect the checkbox which says “Use Local Streaming Server.” Then fill in the proper encoder connection strings and select the protocol. If you use a edge streaming network like Speedera they will provide you with connection information for connecting to their server. Generally you will want to take this information and compose a string like “username:password@hostname[:port]/streamname”. Please contact Webcast in a Box if you need assistance with your edge server connection settings.
   Usage
   Possible usage scenarios for using the remote server settings are when you have the Webcast in a Box appliance in a location where you have ample bandwidth out for a single connection, but cannot provide bandwidth for more than one connection. In this scenario it may be useful to use the Webcast in a Box appliance as an encoder and use a broadcast infrastructure provider like Speeder Networks or Akamai. This is typically useful when using the appliance on a home DSL or cable modem where there is bandwidth outbound for only a single connection. The Webcast in a Box appliance will provide only a single stream up to the infrastructure provider, and the infrastructure provider will handle and distribute the stream automatically to thousands of clients. If you use the Webcast in a Box appliance in this way, make sure you test the appliance fully beforehand to verify that the outbound connection can support a constant connection at the bitrate you have chosen. You may need to experiment with the connection until you determine the actual possible bitrate.
   Special Considerations
   When using the box as a remote encoder, for example when you are in a hotel conference room or in a location where you are renting a connection to the internet, you may need to first accept a license agreement before using the internet connection. In order to do this, it may be necessary to connect to the appliance and use VNC.
   Logging
   All logging for the remote server connections is placed in the “producer” section in the log files, so check there if you experience errors or strange behaviors.
   Usage Scenarios: Remote Archive Usage
   The remote archive feature is useful when your network has a CDN (content distribution network) which is used to mirror content out to edge servers. This feature can also be used as an emergency backup facility in case of hardware failure. The Webcast in a Box appliance is also extremely portable and mobile and there may be times when the archive is unavailable because the appliance is en route to a webcasting event, so placing a remote archive on another server is useful in this situation.
   Archiving Policy
   If the “Use Local Archive” checkbox is checked when a webcast is halted, the presentation will not be uploaded afterwards regardless of the whether the “Use Local Archive” setting is changed later. This way you can choose to archive certain webcasts and not archive others. If you want to archive a webcast which was created when remote archiving is disabled, turn on remote archiving by deselecting the “Use Local Archive” and saving the settings, and then go to the “Program Guide” and select “Upload” from the choices, and click the “Go” link. This will schedule the Webcast for archiving.
   Files
   All files in the archive directory will be uploaded. The archive.smil file has relative paths to the media files while other SMIL files have absolute paths which may be invalid when moved off the Webcast in a Box appliance. When referencing a file which has been uploaded to another server using the remote archive feature, provide URLs to archive.smil and playback will work properly.
   Precautions
   Take note that the remote path information may be handled differently on the remote server depending on the protocol used to upload the media. For example, with an FTP server, the paths “/media” and “media” would likely be treated as the same location in the remote filesystem, “/home/jsmith/media” for example. With SCP however, “/media” would likely resolve to “/media” on a remote server, while the path “media” would probably resolve to “/home/jsmith/media”
   Editing Media
   If a webcast is edited, the system will attempt to upload again media files which have changed. In this way the Webcast in a Box appliance attempts to keep remote files in sync with your local media.
   USB SmartKey
   Prerequisites
   To use the USB SmartKey feature, the appliance should be configured properly so that it is on the network, has a secret key configured, and optionally has a mail server properly specified (in order to send out notification emails). All of these settings can be verified and changed in the “System Settings” section of the web interface.
   Usage
   To use the USB SmartKey feature, just place a properly prepared USB SmartKey into either of the two USB ports on the front of the appliance. The appliance will verify that the SmartKey file is correct, send emails to recipients on the email list, and stop the webcast automatically when the SmartKey is removed. This webcast will be entered into the program guide.
   USB SmartKey Hardware
   Webcast in a Box provides one USB SmartKey with every appliance. If you need to replace it due to loss or breakage, or want to use more than one SmartKey with an appliance, you can use any standard USB key drive.
   Standard SmartKey File
   Every SmartKey used with the Webcast in a Box appliance should have a file called wiab_settings.xml. This is an XML file comprising several elements used to control the appliance. This XML file can be in one of three places: at the root of the drive, directly within a folder called “wiab” or directly within a folder called “webcast”
   Simple Secret Passphrase File
   If you would prefer a simple SmartKey file, you can use a SmartKey with only a simple text file on it. The USB SmartKey must be named file name key.txt somewhere on the SmartKey. The file should have the same string as has been set as the “SmartKey Secret Phrase” string in the “System Settings.” It should be in standard text file format, so be careful not to save the file as RTF (Rich Text Format) or DOC (Microsoft document format). Newlines after the phrase are ignored; the passphrase should be on the first line of the file.
   Email Recipient File
   You may also optionally create a file called email.txt in any of the three places listed above. This file should contain a list of email addresses. The format is somewhat freeform. You can specify email addresses separated by commas, or each address on its own line. Invalid email addresses will be ignored.
   LCD System Messages
   When you start a webcast with the USB SmartKey feature, you will notice status messages output to the LCD display. If the webcast is properly created and started you will see this succession of status messages: “Key inserted,” “Secret key match,” “Priming webcast” and after a few seconds “Started webcast.” There is a delay between the time you see “Priming webcast” and the “Started webcast” as the encoders are “primed”. If you see other messages in the LCD display, other than the standard IP address and channel status messages, you may have experienced an error. Please review the log files if this is the case.
   Read-only Access
   Nothing is written to the the USB SmartKey during operation. Therefore, the SmartKey can be set to read-only, if this feature is available on the hardware as a switch, without causing problems for the webcast.
   Complete Appliance Control
   All settings which are available in the web interface, from creating webcasts with specified profiles, to changing network settings, to using remote archive and remote streaming media servers, can be configured on the SmartKey.
   Network Adjustment

One common use the SmartKey is to adjust the network when you enter a location with the box set to DHCP but need to use a static IP. You can create a wiab_settings.xml which specifies a special static IP address, plug in the SmartKey, and the appliance will switch to that IP address. Note that when the box is rebooted, it will revert to the original setting held before the SmartKey was inserted. This is useful if you are going to use the box for a one-time event and need to adjust the network temporarily, but prefer to retain the original settings. If you would like to continue to use the network settings after the box is rebooted, please go to the “Network Settings” and adjust the IP address information normally. To generate a custom wiab_settings.xml without access to the webcast in a box, visit http://webcastinabox.com/smartkey/.

One common use case is when you are doing a remote webcast from a non-standard location. In this case, you are often provided with an IP event before the event begins, from which you create a custom wiab_settings.xml file and place it on the SmartKey. When the event is to begin, you plug in the SmartKey to switch the network and begin broadcasting.

Logging

The entire sequence of events during a SmartKey generated webcast is logged in the log files under the name “hotplug.” Please check the log files if you experience any errors or unexpected behavior.

Program Guide

Webcast In A Box provides a list of all archived and scheduled webcasts in a single interface called the Program Guide. Each webcast entry dislays a status, title, and date. You may find more detailed information by clicking the title of the webcast. Status values include “archived”, “not archived”, “pending”, and “now showing”. Events with a “not archived” status are previous webcasts where the operator elected to not archive the video. The template settings and other information are saved.

If you click “Status”, “Title” or “Date” once at the top of the Program Guide it will sort that column in descending order. Click it again and it will be sorted in ascending order.

Actions

Each webcast has a drop down menu of actions that change depending upon its status. Depending on the status of the webcast, and certain administrator choices, the options presented in the drop down menu will differ. For example, if the webcast was “archived” the operate option would not be presented.
“View” will launch the RealPlayer and play the webcast.
“Edit” will navigate to the prepare page with the form values preset.
“Duplicate” will navigate to the prepare page with the option of creating a new webcast based on settings from an existing webcast.
“Clone” will create an indentical webcast which can be edited independently of the original. This is useful if you need to create two separate webcasts from one original: you clone the webcast and then clip both of the webcasts to use different in and out points.
“Delete” will delete the webcast.
“Announce” will open the announce window to send email announcing this webcast.
“Operate” will open the operate window so that the webcast can be started. This
option is only available if the webcast status is listed as pending.
“Statistics” will open the statistics window.
“Export” will open the export window for download of files.
“Publish” will publish the webcast to a Webcast in a Box mothership server.
“Upload” will schedule this webcast for upload. This is useful if the archive settings were turned off when the webcast was originally created, or if the settings are changed and you wish to push the files to a different server. The “Upload” choice is available only when you have remote archiving turned on.
   Channel Status
   On every page in the Producer Console including the Program Guide there is a Channel Status region. This region indicates whether each channel is brodcasting (“live”) or idle. It displays the system time when the past was rendered and it displays the remaining disk storage space available for archive purposes.
   Webcast Profiles
   Webcast profiles allow you to layout your presentation, choose which channels of video you would like to provide to your viewers, and assign background colors and images to a presentation.
   Profile Generation
   You may create new webcast profiles by clicking “Webcast Profiles” from the Main Navigational Menu and filling out the provided form. First give the settings a name then choose from four layout options to enable a custom layout with an area for video from a camera, for video from a desktop capture, and for a banner, logo, or background graphic. Both video from the “speaker”, or presenter (camera), and from the “desktop” (scan-converted capture) can be large or small. The template tool will calculate the proper sizes and layout automatically in the “Standard Templates” mode. Click “Preview Template” to approve of the template layout and design, then click “Create Template” to save it.
   Background Colors
   You can choose a background color using the color picker popup. Click on the “paint palette” icon and select a color by clicking on it.
   Uploading Background Images
   Banner, logo, or background images can be uploaded from the Background Image item. This image can be any format which plays in the RealPlayer, such as Flash (SWF), GIF, JPEG and many others. Please visit http://www.realnetworks.com for more information on which datatypes the RealPlayer supports. If you choose to use a background image, it will be displayed over any background color, so please use one or the other.
   Advanced Settings
   By clicking “Advanced Settings,” you are given more granular and manual control over the sizes and positions of each element in the webcast template. Options include the height and width of each element and the top/left pixel positioning from the upper left corner of the RealPlayer player window. You can also select audience settings (codec, bitrate and other options for encoders), whether you wish to enable audio capture, and whether you wish to use a different format than RealNetworks media by selecting an alternative encoder.
   Configuration Options
   You can either configure a static IP address using a computer with a crossover cable, or use a USB SmartKey with a customized XML to switch to a static IP.
   Crossover Configuration
   You will need a laptop or desktop computer (“computer”) with an ethernet port and either a cross-over cable, or a hub and two network cables. If you are using a cross-over cable, plug one end of the cable into the network port on the computer, and plug the other end into the Webcast in a Box appliance into the network port on the rear of the appliance marked “100M” (NOT “1G”; this is the Gigabit port). If using a hub, plug one network cable into the Ethernet port of the computer, and the other end of the cable into one port on the hub. Take the other cable and plug one end into the network port on the Webcast in a Box appliance and the other end of the cable into another port on the hub.
   Microsoft Windows Configuration
   The computer must be configured so that it has a static IP address of 10.10.10.2. First, go to the “Start Menu”, select “Settings” and then select “Network Settings” (Under Windows XP it may be labeled “Control Panel” with “Local Area Network”). If your cables are plugged in properly you should see at a single icon with two small computers with small green screens. Click on the icon (or whichever of the icons is for your network card interface), and select TCP/IP Settings. If you do not know how to reconfigure your network settings on your own, please note on paper the existing settings so you can restore them later. Select “Use Static Address” and type in 10.10.10.2 into the IP address settings, with 255.255.255.0 for the Netmask, and 10.10.10.1 for the Gateway. Click “OK” to close the dialog. You may have to reboot your machine. Once this is done, go to the “Start” menu, click “Run” and type “cmd” (or “command” for Windows 95 and older versions.) A “command window” should appear. Type “ping 10.10.10.1” followed by return. If you see something like this:
   ping 10.10.10.1
   PING 10.10.10.1 (10.10.10.2) 56(84) bytes of data.
   64 bytes from 10.10.10.1: icmp_seq=1 ttl=64 time=0.368 ms
   If you see this, your machine is properly configured to talk to the Webcast in a Box appliance, and you can skip to the section below marked “Using the Web Interface.” If you do not see this, your network is not properly configured between the two machines. Contact your network administrator, or Webcast in a Box at support@webcastinabox.com.
   Linux Configuration

To configure the computer under Linux, you must have superuser (“root”) access. Open a terminal window, such as “xterm” or “konsole.” Type this command:

bash-2.05b# ifconfig eth0 10.10.10.2

Then, type:

bash-2.05b# ping 10.10.10.1

PING 10.10.10.1 (10.10.10.2) 56(84) bytes of data.

64 bytes from 10.10.10.1: icmp_seq=1 ttl=64 time=0.356 ms

If you see something similar to the above messages, your network is properly configured and you can continue ahead to the next section “Using the Web Interface” If there is no output or response from this command, your network is not yet configured properly. Contact your network administrator or Webcast in a Box at support@webcastinabox.com

Web Interface Usage

Once you have the network configured properly, you can use the Web Interface to configure a static IP address. Start a web browser on the computer plugged into the Webcast in a Box appliance. Type 10.10.10.1 into the location bar. You should see the entry page to Webcast in a Box. Click on the “Producer Console” link. Enter your login information for the administrator. If you have never used the Webcast in a Box appliance, the administrator password will be “changeme” Once you have logged in, choose “Network Settings” from the navigation bar on the left. Uncheck “Use DHCP” and enter in your network settings for IP address, netmask, and gateway. Then, click “Save Settings” at the bottom of the page. You should then look at the LCD display on the face of the appliance. When you see the “IP Address” displayed it should show the IP address you have configured. Pay attention also to the gateway information.

Verifying Gateway

At this point the gateway you configured should not be routable since the appliance is not plugged into the real network. Therefore, you should see a “*” in front of the IP address you configured. Plug the appliance into the real network with a network cable connected to the network plugged into the 1G port on the back of the appliance. Once the computer is properly on the network, you should see that the gateway is accessible to the appliance, and the “*” should disappear from in front of the gateway IP address. If not, please verify your settings or contact your network administrator. Now, unplug the network cable plugged into the 100M ethernet port on the appliance. You can have cables in both the 100M port and the 1G port without conflict while your configure the appliance.

Use Cases

It may be necessary for you to operate the Webcast in a Box as if you were logged into it as a normal desktop appliance. When you are off site and attempting to acquire a network address from within a hotel conference room, you may need to open a web browser and accept a license or pay a fee in order to acquire a network IP address. This process is termed “validating the IP address” hereafter. You could operate the Webcast in a Box appliance with a monitor, mouse or keyboard, but you can also access the desktop virtually using VNC. In order to do this, you need to access the appliance over a network, either via a wireless connection or other computer, or by using a crossover cable on the control port

Wireless Connection

It may be possible to access the Webcast in a Box appliance using a laptop which has acquired a network address from a wireless network. The Webcast in a Box appliance will probably not be able to route out to the Internet before validating the IP address, but it is possible it can access other machines on the same subnet. If your wireless IP address is within this subnet, you may be able to use your laptop to connect to the box before the IP address has been validated. To determine whether this works, look on the LCD to see if an IP address has been acquired via DHCP; if so, enter this into your web browser location bar and attempt to access the web interface.

It is also possible that another computer on the network (perhaps in a business center) can be used to access the IP address of the appliance, if they share a subnet.

Crossover Configuration

If you don't have a laptop with a wireless adaptor, or you cannot access the box because it is on a different subnet, you will have to use a crossover cable to access the appliance.

Server Activation

First, login to the Webcast in a Box appliance web interface. Then, go to the “System Settings” section and click on the link “Start VNC.” This will launch a new window with the VNC client embedded inside it. This client requires that your browser supports Java applets. If you do not have a Java enabled browser, you will see a link to download and run native client instead. If you don't see the “Start VNC” link on the “System Settings” page then it has not been installed. Click on the button at the bottom of the “System Settings” page called “Component Update.” In the textfield, enter “VNC” and click “Add to Update List.” Then click on the “Update” button and follow the steps there to upgrade the VNC components.

Password Modification

You may change the VNC password by entering a new password and clicking the “Change VNC Password” button.

Usage

Once you have started VNC, you must access it either via the Java applet or from the native client. In either case, you will be presented with a password entry. Enter “wiabvnc” for the password (or whatever you have changed it to). Once you are logged in, you will see a standard computer desktop. From here you can open a web browser by clicking on the “Firefox” link on the desktop, or by going to the “Start Menu.” If you are attempting to validate an IP address, opening Firefox should take you immediately to the validation page. If not, you may need to enter a website address like “yahoo.com” in order to be redirected. From there you can register your IP address in whatever method is appropriate.

Server Deactivation

Once you have finished with your session, click the “Logout Button” within the VNC window. Then click on the “Stop VNC Server” link to stop VNC, and then close the VNC window. You should always halt VNC when you are finished. For security reasons, VNC will automatically halt after 15 minutes. If you need to restart the service, click on the “Restart VNC” to refresh the page and restart VNC.

Hardware

Webcast In A Box is based upon the Shuttle XPC chassis model SB52G2. It has a 3 GigaHertz CPU, 1 GigaByte of RAM, and a 200 GigaByte hard drive. It has a LCD display from Crystal Fontz and two Osprey 210 video capture cards from ViewCast. Included with the system is a scan converter from AverMedia as well as A/V cables and adapters that allow desktop capture. A power cable is provided.

Software

Webcast In A Box runs on SuSE Linux 8.2 with a 2.4.22 kernel. Apache 1.3.28 with mod_perl and mod_ssl is used to generate HTML using HTML::Mason. Proftpd server 1.2.8, mySQL 3.23.58, with Helix(TM) Producer Plus 9.0.1 from RealNetworks(R). Build number: 9.0.1.250 and Helix DNA Server 10.1 (10.1.0.748) are also installed.

Troubleshooting

Problem: Video is black or no picture:

Resolution #1: Is the correct video input plugged in? Click on the “Channel Status” link from the Operator Console to bring up the live encoder state settings page. If the “Video Input” is “Composite” do you have a yellow cable from the camera or scan converter plugged into the dongle going into the capture card? If the input is set to “S-Video” do you have an “S-Video” cable plugged into the dongle?

Resolution #2: Is the bandwidth in your RealPlayer set correctly? If you are streaming at 200 Kbps and your player preferences are set to “56 K modem” the RealPlayer will drop frames and packets in order to try to keep bandwidth beneath your threshold.

Resolution #3: Is the video dongle plugged into the correct capture card? For presenter (channel #1) capture the dongle should be plugged into the capture card toward the middle of the appliance; for desktop (channel #2) capture plug the dongle into the capture card on the outside edge of the appliance.

Problem: After clicking “Start” in the Operator Console, the webcast dies almost immediately after starting.

Resolution 1: Are you using a custom audience (RPAD) file for this webcast? If so, the RPAD file may be invalid. Or, you may have misnamed the RPAD file such that it was recognized as RealVideo 8 when in fact it is RealVideo 9. You cannot mix RealVideo 8 and 9 RPAD files when doing a SureStream webcast. Review the log files for the “producer” in the Access Logs section.

Resolution 2: If you are using the appliance as a satellite or encoder appliance, your network may be inaccesible causing the encoders to fail when they attempt connection the server.

Problem: USB SmartKey cannot start webcasts.

Resolution: Is the wiab_settings.xml or key.txt file on the USB drive? Is the file saved as “text’ If the file was saved as a format other than text (.DOC or RTF) then the SmartKey file cannot be read by the Webcast in a Box appliance. Is the key.txt in the root of the drive, or in a directory either named “wiab” or “webcast”

Persons skilled in the art will recognize that many modifications and variations are possible in the details, materials, and arrangements of the parts and actions which have been described and illustrated in order to explain the nature of this inventive subject matter and that such modifications and variations do not depart from the spirit and scope of the teachings and claims contained therein.

Currently claimed inventions:

1. A system, comprising a media encoder configured to:
(i) capture media from a media source device associated with the encoder and to store it as a media file; and
(ii) removably receive via an interface a hardware key for activating the capture of media on the media encoder upon connection of the key to the interface and to deactivate a capture on removal of the key.

2. The system of claim 1 wherein the media source from which media is captured is a video or audio device for live capture and transfer to the media encoder.

3. The system of claim 2 wherein the encoder is configured so that removal of the key initiates publication of at least a portion of the captured media.

4. The system of claim 1 further comprising the key.

5. The system of claim 1 wherein the encoder is configured to process one or more data files on a key, the data directing the encoder to (i) publish the captured media to specified network locations that are accessible by users; (ii) set capture parameters (d); (iii) authenticate security parameters; (iv) perform specified logging related that can assist a user or administrator in troubleshooting the operation of the system; (v) configure networking parameters; and/or (vi.) send specified notifications like notifying users that media files are published, or notifying administrators that errors have occurred in the capture process.

6. The system of claim 3 wherein the key includes one or more data files created by a user's interaction with a web form.

7. The system of claim 1 wherein the media source from which media is captured is a video or audio device for live capture and transfer to the media encoder.

8. The system of claim 1, wherein the system publishes the digital media files to a remote system such that the remote location can be specified in digital information stored on the key or on the system before insertion of the key.

9. A method, comprising:
enabling the configuration of a hardware key removably connectable to a media encoder, the media encoder configured to: (i) capture media from a media source device associated with the encoder and to store it as a media file; and (ii) removably receive via an interface the hardware key; and
configuring the key with one or more data files on a key, the data directing the encoder to (i) publish to of the captured media to specified network locations that are accessible by users; (ii) set capture parameters (d); (iii) authenticate security parameters; (iv) perform specified logging related that can assist a user or administrator in troubleshooting the operation of the system; (v) configure networking parameters; and/or (vi.) send specified notifications such as notifying users that media files are published, or notifying administrators that errors have occurred in the capture process.

10. A method, comprising configuring a media encoder to:
(i) capture media from a media source device associated with the encoder and to store it as a media file; and
(ii) removably receive via an interface a hardware key for activating the capture of media on the media encoder upon connection of the key to the interface and to deactivate a capture on removal of the key.

11. The method of claim 10 further comprising enabling configuration of a key with one or more data files for directing the encoder to (i) publish to of the captured media to specified network locations that are accessible by users; (ii) set capture parameters (d); (iii) authenticate security parameters; (iv) perform specified logging that can assist a user or administrator in troubleshooting the operation of the system; (v) configure networking parameters; and/or (vi.) send specified notifications such as notifying users that media files are published, or notifying administrators that errors have occurred in the capture process. , and wherein the media source from which media is captured is a video or audio device for live capture and transfer to the media encoder.

12. The method of claim 11 wherein the encoder is configured so that removal of the key initiates publication of at least a portion of the captured media.

13. The system of claim 1 further configuring the encoder to communicate a media server to which digital media is published using at least two layers of security to help prevent unauthorized access to the media server and/or the encoder.
